(19) United States
(12) Patent Application Publication
(10) Pub. No.: US 2009/0025278 A1
(43) Pub. Date: Jan. 29, 2009

(54) PRODUCTION OF BIOMASS FUEL

(76) Inventor: Hans Werner, Munchen (DE)

Correspondence Address: MILES & STOCKBRIDGE PC, 1751 PINNACLE DRIVE, SUITE 500, MCLEAN, VA, 22102-3833, US

(21) Appl. No.: 11/883,484

(22) PCT Filed: Feb. 1, 2006
(86) PCT No.: PCT/EP06/00950

§ 371 Date: Mar. 4, 2008

(30) Foreign Application Priority Data
Feb. 1, 2005 (DE) 10 2005 004 634.7

(51) Int. Cl. C10L 1/18; B01J 19/00

(52) U.S. Cl. 44/307; 422/309

(57) ABSTRACT

Method and device for producing fuel from molded biomass in which the biomass used is dried biological wastes or fermentation products resulting from wet and/or dry fermentation, and/or silage products, and/or other dry or moist biological wastes.

The present invention relates to a method and a device for producing fuel from biomass, and to uses of same.

In addition to fossil fuels, energy sources in the form of biomass are being used to an increasing extent. Biomass is taken to mean, in particular, plants, plant components, biological products and byproducts of plants and animal origin, and wood.

Customarily, in energy production by means of biomass, it is simply burnt. This procedure has a plurality of disadvantages. Depending on the type of biomass to be burnt, transport, storage and handling before or during burning can render this significantly more complex compared with fossil fuels. The use of straw as fuel is mentioned here as a clear example.

Owing to its high energy content, wood is a preferred biomass. In order also to be able to use wood in the form of wood wastes, chippings and the like, U.S. Pat. No. 4,324,561, for example, discloses producing what are termed wood pellets by compressing wood particles and using them for energy production. U.S. Pat. No. 4,324,561 further discloses producing fuel pellets based on tree balk, straw and other botanical materials.

The use of cereal-based straw as starting material for producing fuel, in particular based on rye or wheat, is also disclosed by U.S. Pat. No. 5,352,252.

U.S. Pat. No. 4,363,636 describes the use of sugar cane-based fuel.

EP 0 985 723 A2 describes the production of solid fuel based on a cellulosic fuel component, in particular wood, wood-like substances and chippings and a further component containing horse manure.

According to DE 101 53 975 A1, fuel based on biomass of high specific density and high fat and/or oil proportion is produced. In particular, it is provided to use shells and kernels of fruit and nuts and also palm leaves.

CH 248 748 describes the production of briquettes from plant materials, such as, for example, waste from wood processing, peat, hemp stem core, straw, tan bark, potato tops, sunflower seed husks and corn cobs.

EP 1 443 096 A1 discloses, instead of dry biological materials, processing wet biomass such as, for example, grass and, before compression to form pellets, comminuting it and drying it.

In addition, DT 26 16 725 A1 proposed subjecting wet biomass, before compression, to a fermentation (rotting) and using the resultant heat for drying the mass.

In this connection, DT 26 16 725 A and DE 197 07 848 A1 indicate that the fermentation leads to improved stability of the pressed material.

The amount of biomass-based fuels according to the prior art is not currently sufficient to cover the increasing requirement. In addition, biomass fuels according to the prior art are generally provided for use in industrial plants. Use of biomass fuels in private households is typically not provided. On the other hand, biomass, in particular in the form of waste, is available in virtually unlimited amounts. It is currently at best composted and then, because the available amounts exceed requirements, is frequently landfilled, so that its energy content is unused.

It is an object of the present invention to cover the increasing requirement of biomass fuels in a simple and inexpensive manner and to make biomass fuels at the same time usable to a greater extent for private households.

To achieve this object, the invention provides a method for producing fuel from molded biomasses, in which, as biomasses, use is primarily made of wastes, in particular also mixtures of different wastes such as various dry wastes according to claim 1, but especially also wet wastes, and also mixtures of wet wastes and/or dry wastes, in particular also mixtures with fermentation and/or silage products according to claims 2 to 4.

The wordings “molded”, and also “compression molding” and the like are used hereinafter in order to specify that the biomass is pressed, compacted, compressed and the like. In this manner, fuels can be produced in handleable piece form. Examples are biomass fuels in the form of granules, moldings, pellets, briquettes and molded pieces of greater dimension. The shape of fuels according to the invention depends, for example, on in what manner or with what devices they are to be burnt. For instance, for use for heating in private households, fuels according to the invention are offered in the form of moldings, pellets or briquettes. When fuels according to the invention are used in relatively large energy production plants, such as, for example, biomass power stations, moldings of relatively large volume can be used. The use of fuels according to the invention in the form of granules permits combustion in small devices, for example pocket heaters, camping stoves.

In wet and dry fermentation of biomass, combustible gases are formed which can be used for energy production. After fermentation, that is to say when the biomass is fermented to exhaustion, biomass remains which was previously composted. This compostable biomass and/or compostable biomass which was not subjected to a previous fermentation process, is contemplated for use in the present invention. Previously, compostable biomass, if it had not been disposed of, was composted. This led to amounts of compost which generally could only be passed onto agricultural enterprises, for example, at a loss, under subsidy. A use of compostable biomass as starting material for fuel production, which would solve this problem, has not previously been mentioned. In contrast thereto, such biomass in the present invention is provided for fuel production which not only represents a turning away from the conventional procedure, but rather the present invention opens up new possibilities for utilizing biomass which, arising as byproduct or surplus, had been used for fermentation or composting, and for composting or fermenting biomass which has been cultivated in a targeted manner. In particular, by means of the present invention, targeted cultivation of such biomass opens up novel perspectives. This also applies to silage products provided in the present invention.

The use, in particular in the form of an addition of sewage sludges and the like which are produced in a great quantity and otherwise can only be landfilled, also comes into consideration.

In the case of most other types of waste provided according to the invention, use for fuel production has also hitherto either been unknown, or if they have already been used for energy production, in any case use for fuel production within the meaning of the present invention, in particular in the form of combustible moldings, is not known. These types of waste have hitherto been at best comminuted, but have been essentially burnt unprocessed.

According to the invention, preference is given to the use as biomass of what is termed biorefuse or biowaste, such as is produced, for example, in private households or else in commercial enterprises such as restaurants or retail sites and is collected in what are termed “brown bins”. Examples hereof are fruit, fruit residues, fruit peel, fruit stones, vegetables, vegetable residues, salad, salad residues, flowers, flower residues, plants, plant residues, coffee, coffee residues, tea and tea leaves and also residues thereof.

Preferably, in the method of the invention, the biomass, where necessary, is dried by means of an industrial method before it is molded.

Drying the biomass before compression molding permits any desired biomass to be used independently of its moisture content, in particular also such biomass which because of its excessive moisture content has hitherto remained out of consideration. The procedure not only to dry biomass, but also to press it, leads to fuels having increased calorific values or energy contents per mass and/or volume, and also decreased transport volume, compared with conventional approaches.

In order to simplify the drying process and/or to produce fuels in any desired form, it is preferred to comminute the biomass before drying. This can be performed, for example, by chopping, shredding and the like.

In particular in the case of biomass having a high moisture content, it is preferred to press this before drying in order thereby to reduce the moisture content which is to be removed by drying. In order to facilitate pressing and/or improve it, the biomass can be comminuted in advance. The biomass which is partially dewatered by pressing can be of such a quality that the actual drying process is made difficult. It can, for example, be compressed or lumpy. In this case it is provided to comminute the biomass again after the pressing process in order to facilitate the further drying.

For drying the biomass, use can be made of condensation drying at ambient temperature, or at a temperature increased over ambient temperature (for example warm air feed, other warmed gas). The drying can also be achieved only by warmed gases, for example in the form of hot air, warmed industrial gases and combinations of same. In particular, it is preferred to utilize for drying waste heat resulting in other methods or devices which is formed, for example, in composting or fermentation with biomass, in silage processes, in combined heat and power stations or in rooms or buildings in private households or in the industrial sector. In this case use can be made of, for example, heat pumps, in order to feed waste heat to the drying process. As set forth below, it is also possible to generate energy required for drying at least in part by burning fuels produced according to the invention. Alternatively, or supplementary thereto, it is provided to use a microwave heater for drying.

The temperatures of the surroundings of the biomass used in drying, or the temperatures produced in the biomass on drying depend on the type of biomass, the desired or preset drying duration, a desired or, for example, legally required, degree of efficiency on drying.

On drying, also, substances present in the biomass to be processed can be removed, which substances make its processing difficult and/or adversely affect combustion of the biomass fuel. For instance, for example odor nuisance, emissions harmful to health or of concern to health, smoke development and the like can be avoided on combustion of fuel produced according to the invention.

In order to decrease emissions produced on combustion of fuels produced according to the invention, it is provided, for example, to remove by suction gases formed or liquids arising on drying the biomass and, for example, to pass them through suitable exhaust gas or filter devices and if appropriate to dispose of them as special waste. Such method steps can also be carried out alternatively, or as a supplement, in any other step of the process according to the invention.

According to a preferred embodiment, the biomass is pressurized on drying and, for example after a predetermined or desired drying duration, exposed to ambient pressure still in the warmed state. The change in pressure occurring in this causes additional moisture to exit from the biomass.

Because the biomass is dried before the compression molding, it is possible to process different types of biomass in mixed form without paying attention in this case to the moisture content of individual types of biomass. If different types are used in mixed form, at least the drying process and, preferably, if present, also the comminution process or processes and/or the pressing process must be designed accordingly. Although this can lengthen the individual method steps and make them more complex, it does permit any desired biomass to be used without previous separation into individual types.

If different types of biomass are present separately, the individual method steps can be carried out separately for each type. This permits the individual method steps to be matched better to the respective type of biomass and to produce fuel which is based on only one type of biomass.

When for different types of biomass the individual method steps, apart from compression molding, have been carried out, the different types can be mixed and molded together. In this manner it is possible to produce fuels which are based on different types of biomass and contain biomass of varying composition and/or varying proportions. Such a combination of different types of biomass enables, for example, in addition to biomass of high heating values to be used for producing a fuel, biomass of low heating value also to be used which, because of its low heating value, would not be selected alone for fuel production. Also, different types of biomass can be combined for production of a fuel in such a manner that emissions of different biomass types compensate for each other on combustion or react with one another in such a manner that unwanted emissions which would have formed in the case of separate combustion, are avoided.

The types of waste provided according to the invention have not been considered suitable previously for production of fuel. This is due, inter alia, to their moisture content and the fact that they are suitable in part for composting. Use of these biomasses according to the present invention represents a fundamental turning away from their previous estimation and use.

For generating the energy required for carrying out the process according to the invention, in particular the heat required for drying, apart from conventional fossil fuels, use can be made of wind energy or solar energy and also fuels produced according to the process of the invention. In addition, it is possible by combustion of fuels produced according to the invention to generate electrical energy and to use this in carrying out the process.

In the use according to the invention it is provided to use fuels which are produced according to one of the above described methods to generate energy in the form of heat and/or power by combustion in a furnace, an oven, a heating plant or the like.

In addition, the present invention provides a device for producing fuels from pressed biomass with a unit for compression molding biomass which is designed in such a manner to press dry biomass, or else mixtures of various types of biomass, in particular those of wet and dry biomass types, especially also in the form of fermentation products and/or silage products and/or at least one of the abovementioned types of waste.

Preferably, the device according to the invention, if it processes only dry biomass, comprises a unit for comminuting the biomass before compression molding.

If moist biomass is also processed, the device according to the invention further comprises a unit for drying which is connected upstream of the compression molding unit and is designed for drying moist biomass, also in the form of fermentation products and/or silage products.

Also in this case, the device according to the invention further comprises a unit for comminuting the biomass before drying and/or preferably, in addition, a unit for pressing the biomass before it is fed to the drying unit. It is provided in this case that the comminution unit is connected upstream of the press unit or vice versa or that a comminution unit is used not only before but also after the press unit.

In a preferred embodiment of the device according to the invention, the drying unit comprises a drying chamber for receiving the biomass, if appropriate, comminuted and/or pressed, which is heated by means of a warmed gas and/or by means of a microwave heater in such a manner that the biomass, after completion of the drying process, has a desired or predetermined moisture content.

In order to prevent, for example, gases and/or fluids formed during drying from being able to escape, it is provided to seal the drying unit gas- and/or fluid-tightly during drying. In this manner, gases and/or fluids collected can be drawn off by suction, removed and, if required, disposed of. If gases are formed during drying of the biomass, this embodiment permits the drying unit to use the resultant gas pressure in order to pressurize the biomass on drying, as described above.

Means of a unit for controlling the pressure acting on the biomass on drying, the drying process can be improved, if, for example, after a predetermined time period, the still warmed biomass is exposed to a pressure drop.

In particular when biomass is presented and dried in separate form, the device according to the invention preferably comprises a unit for mixing the different types of dried biomass before it is molded. Alternatively thereto, it is provided that the device according to the invention has a unit for mixing the biomass before drying, if appropriate also before comminution and/or pressing. The latter has the advantage that types of biomass provided in separate form can be processed together.

In order, for example, to supply the device according to the invention itself with energy, at least in part, it can have a unit for generating energy by burning fuels produced by means of the device. The energy generation unit can, for example, be a unit providing thermal energy to the drying unit (for example oven) and/or a unit feeding electrical energy to the device according to the invention.

### BRIEF DESCRIPTION OF THE FIGURES

In the description of preferred embodiments of the present invention, reference is made to the accompanying figure which shows:

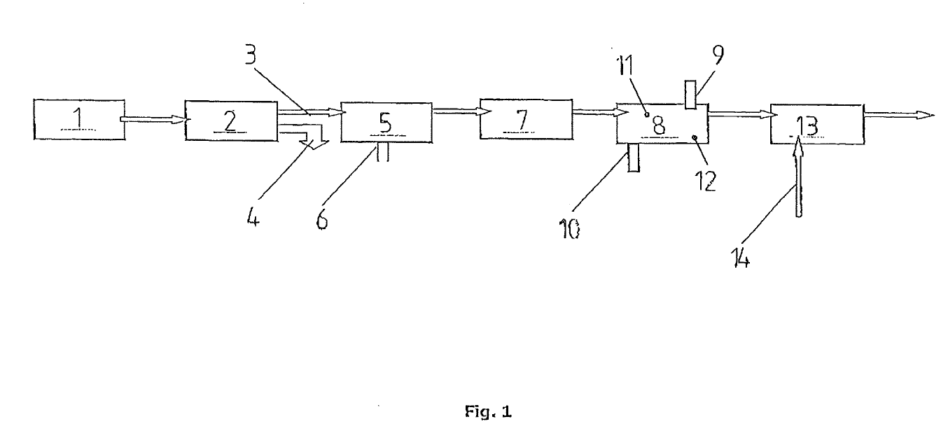

In FIG. 1 a diagram of a preferred embodiment of the device according to the invention for producing fuels from pressed biomass.

### DESCRIPTION OF PREFERRED EMBODIMENTS

Referring to FIG. 1, an embodiment of the device for production of fuels from pressed biomass in the form of combustible pellets and also of its operation are described, wherein for illustration, reference is made to biomass in the form of what is termed biorefuse or biowaste, for example from private households and restaurant operations.

Biomass is collected in a collection unit 1, for example a container. The biomass received in the collection unit 1 can be of different types and/or origin and be present in mixed form. For the sake of simplicity, hereinafter it is assumed that one type of biomass, namely biorefuse, is received in the collection unit 1.

The biorefuse is transported from the collection unit 1 to a comminution unit 2 which can be, for example, a shredder, chopper, etc. In order to remove impurities possibly present in the biorefuse, it is provided that the comminution unit 2 has a unit which is not shown in this figure which is structurally integrated or downstream in order to transport further comminuted biorefuse and impurities separately. This is indicated in FIG. 1 by the arrow 3 showing the transport of comminuted biorefuse and by the arrow 4 showing the removal of impurities.

The comminuted biorefuse is transported by the comminution unit 2 to a pressing unit 5 in order to withdraw water from the biorefuse by pressing. Water or other fluids arising in the course of this are removed via an outlet 6.

If the biorefuse, after pressing in the pressing unit 5 has a quality which makes its drying difficult and, in particular, extends the drying time and/or can require a higher energy input on drying, the biorefuse, after it leaves the pressing unit 5, is fed to a further comminution unit 7.

The biorefuse thus predried is transported from the unit 7 to a drying unit 8 where it is warmed by means of one or more warmed gases (for example hot air), by means of a microwave heater, by means of an electric heater and/or the like. Vapors forming on drying, in particular water vapor, water produced or moisture produced can be removed via a waste gas channel 9 or a fluid outlet channel 10. By means of a temperature sensor 11, the temperature of the biorefuse to be dried and/or of the surroundings present in the drying unit 5 can be measured in order, for example, to prevent unwanted ignition of the biorefuse and to control the drying process. To check whether the biorefuse to be dried in the drying unit 8 has a desired or demanded moisture content, a moisture meter 12 is used.

In the drying unit 8, the biorefuse can be warmed at a pressure elevated compared with the ambient pressure. If the pressure is reduced to ambient pressure toward, or at the end of the drying process, owing to the pressure difference between the warmed biorefuse and its surroundings, water, where still present, exits from the biorefuse.

After the drying process, the dried biorefuse is transported from the drying unit 8 into a compression molding unit 13, for example a pelleting unit, and formed into moldings, for example pellets.

When moldings are to be produced from biorefuse and other biomasses, the other biomasses can be treated separately until completion of the drying process. This can be carried out successively, using the units 1, 2, 5, 7 and 8, or essentially simultaneously, in parallel in these corresponding additional units. The latter case is indicated in FIG. 1 by the arrow designated 14 which illustrates the feed of another dried, optionally comminuted and/or pressed, type of biomass. This, together with the biorefuse obtained from the drying unit 8, is mixed in a unit which is not shown and fed to the pelleting unit 13 in order to produce pellets which are based on different types of biomass.

### REFERENCE SIGNS

1 Collection unit
2 Comminution unit
3 Transport unit
4 Unit for transporting away impurities
5 Pressing unit
6 Fluid outlet
7 Further comminution unit
8 Drying unit
9 Exhaust gas channel
10 Fluid outlet
11 Temperature sensor
12 Moisture meter
13 Compression molding unit/pelleting unit
14 Feed for other biomasses

1. (canceled)

2. A method for producing fuel from molded biomass in which the biomass is molded from fermentation products resulting from wet and/or dry fermentation and/or silage products and other moist and/or dry biological wastes.

3. The method as claimed in claim 2, in which the dry biological wastes used are wastes from paper, cardboard and textile natural fibers and also wood, alternatively or together.

4. The method as claimed in claim 2, in which, as other moist biological wastes, use is made of wastes from plant tissue including garden, park and cemetery wastes, including foliage, branches, roots and other plant components,
wastes from the preparation and processing of plant tissue to form food or animal feed including wastes from the production of canned products,
wastes from the preparation and processing of fruit, vegetables, cereals, edible oil, cocoa, coffee, tea, tobacco, yeast and yeast extract, molasses, domestic and commercial kitchen waste, fouled straw,
wastes from animal tissue, including wastes from the preparation and processing of meat, fish and other foods of animal origin, including waste from production of canned products,
animal excreta including stable manure and liquid manure, sewage sludges,
biological street sweepings and biological wastes from drain cleaning,
other organic substances of natural materials including fats and waxes, including edible oils and fats, alternatively or together.

5. The method as claimed in claim 2, in which the biomass, before the pressing processing, is subjected to a comminution process.

6. The method as claimed in claim 5, in which the biomass, after the first comminution process, is subjected to a pressing process.

7. The method as claimed in claim 6, in which the biomass, after the pressing process, is subjected to a second comminution process.

8. The method as claimed in claim 7, in which the biomass is dried by means of a warmed gas.

9. The method as claimed in claim 7, in which the biomass is dried by means of a microwave heater.

10. The method as claimed in claim 7, in which the biomass is exposed to drying under pressure and thereafter to ambient pressure in the warmed state.

11. The method as claimed in claim 7, in which biomass of different types and/or origin is molded which is present in mixed form.

12. The method as claimed in claim 11, in which biomass of different types and/or origin present in separate form is dried separately and not mixed until used for compression molding, or biomass of one type and/or origin is molded.

13. The method as claimed in claim 12, in which, on compression molding of the biomass, granules, moldings, pellets or briquettes are produced.

14. The method as claimed in claim 13, in which energy to carry it out is generated at least in part by burning fuel produced according to the method.

15. The use of fuel produced according to the method of claim 2 for generating thermal and/or electrical energy by combustion.

16. (canceled)

17. (canceled)

18. The device as claimed in claim 17, wherein the device comprises a unit (5) for pressing the biomass which is connected upstream of the drying unit (8) and downstream of the first unit (2) for comminuting the biomass.

19. The device as claimed in claim 18, wherein the device comprises a second unit (7) for comminuting the biomass which is connected downstream of the pressing unit (5) and upstream of the drying unit (8).

20. The device as claimed in claim 18, wherein the drying unit (8) comprises a drying chamber which is warmable by means of a warmed gas and/or an electrical heater and/or by means of a microwave heater.

21. The device as claimed in claim 20, wherein the drying unit (8) can be sealed gas-tightly and/or fluid-tightly for drying.

22. The device as claimed in one of claim 21, wherein the drying unit (8) comprises a unit for controlling the pressure acting on the biomass during drying.

23. The device as claimed in claim 21, wherein the drying unit (8) comprises a drying chamber which is warmable by means of a warmed gas and/or an electrical heater and/or by means of a microwave heater.

24. The device as claimed in claim 21, wherein the drying unit (8) can be sealed gas-tightly and/or fluid-tightly for drying.

25. The device as claimed in claim 21, wherein the drying unit (8) comprises a unit for controlling the pressure acting on the biomass during drying.

26. The device as claimed in claim 21, having a unit for mixing the biomass before and/or after drying.

27. The device as claimed in claim 21, having a unit for generating thermal and/or electrical energy by combustion of fuel produced by means of the device.

28. The device as claimed in claim 21, having a unit for generating thermal and/or electrical energy by combustion of fuel produced by means of the device, wherein the energy production unit serves for energy supply during operation of the device.

29. The use of the device as claimed in claim 21, for producing fuel from biomass according to one of claims 1 to 6.
